(19) United States
(12) Patent Application Publication
(10) Pub. No.: US 2006/0285467 A1
(43) Pub. Date: Dec. 21, 2006

(54) Optical disk apparatus and method of evaluating optical disks

(76) Inventors: Hidemitsu Senoo, Osaka (JP); Koji Hayashi, Gifu (JP)

Correspondence Address: FISH & RICHARDSON P.C., P.O. BOX 1022, MINNEAPOLIS, MN, 55440-1022, US

(21) Appl. No.: 11/259,369

(22) Filed: Oct. 27, 2005

(30) Foreign Application Priority Data
Oct. 28, 2004 (JP) 2004-313359

(51) Int. Cl. G11B 20/10; G11B 7/00

(52) U.S. Cl. 369/59.17; 369/53.22; 369/59.21

(57) ABSTRACT

An optical disk apparatus which evaluates an optical disk based on a reproduced signal from the optical disk comprises a delay circuit that has a plurality of first delay elements connected in series which have a binarized signal of the reproduced signal supplied to one end of the series and delay the binarized signal in a sequence to the other end, a data hold circuit that holds level data of the binarized signal obtained from at least one of the plurality of first delay elements of the delay circuit, and a processor that determines whether the binarized signal is at one level or at the other level based on the level data.

### CROSS-REFERENCE TO RELATED APPLICATIONS

The present application claims priority from Japanese Patent Application No. 2004-313359 filed on Oct. 28, 2004, which is herein incorporated by reference.

### BACKGROUND OF THE INVENTION

1. Field of the Invention

The present invention relates to an optical disk apparatus and a method of evaluating optical disks.

2. Description of the Related Art

To date, evaluation apparatuses called “jitter meters” have been used as apparatuses of evaluating optical disks. See for example Japanese Patent Application Laid-Open Publication No. H11-167720. Such evaluation apparatuses evaluate quantitatively to what degree a playback signal obtained from an optical disk deviates in timing, which is called jitter. The dedicated jitter meter is expensive, and jitter cannot have been evaluated readily and inexpensively. Accordingly, a method of evaluating jitter by using an apparatus for recording and/or playing back information onto and/or from optical disk (hereinafter called an optical disk apparatus) has been proposed.

FIG. 11 shows a CD recording/playback apparatus 100 having a jitter evaluation function. First, the usual operation of playing back an optical disk 11 by the CD recording/playback apparatus 100 will be described.

An optical pickup 10 receives reflected light of laser light irradiating the optical disk 11 and picks up the high/low in intensity of the reflected light to output in the form of a change in voltage value. A servo circuit 12 performs tracking servo, focus servo, and the like of the optical pickup 10 with respect to the optical disk 11 so that the optical pickup 10 can read out in the correct order, data corresponding to pits and lands recorded on the optical disk 11.

A binarizing circuit 13 reads changes in voltage output from pickup 10 and produces an EFM signal. This EFM signal has a repetitive pattern of High and Low levels. The time periods of the High and Low levels vary between 3T and 11T, nine different time periods, where 1T is the time period of 1 bit that is about 230 ns.

A digital signal processing circuit 14 performs EFM-demodulation on the EFM signal supplied from the binarizing circuit 13, and performs CIRC (Cross-Inter leave Reed-Solomon Code) decoding on the EFM-demodulated signal to produce CD-ROM data. A CD-ROM decoder 15 performs error detection and error correction on the CD-ROM data supplied from the digital signal processing circuit 14 and outputs to a host computer (not shown).

A buffer RAM 16 is connected to the CD-ROM decoder 15, and temporarily stores CD-ROM data supplied from the digital signal processing circuit 14 to the CD-ROM decoder 15 on a block unit basis. The buffer RAM 16 is usually a DRAM in order to store a large amount of data.

A microcomputer 17 is constituted by a so-called one-chip microcomputer having a ROM and a RAM incorporated therein, controls the operation of the CD-ROM decoder 15 according to a control program recorded in the ROM, and at the same time, temporarily stores command data supplied from the host computer and sub-code data supplied from the digital signal processing circuit 14 in the incorporated RAM. By this means, the microcomputer 17 controls the operation of each component in response to instructions from the host computer, to make the CD-ROM decoder 15 output desired CD-ROM data to the host computer.

Next, a method of evaluating jitter of the optical disk 11 in the CD recording/playback apparatus 100 will be described.

The pickup 10, the optical disk 11, the servo circuit 12 and the binarizing circuit 13 are controlled by the microcomputer 17 to operate in the same way as in the playback operation for the optical disk 11, but the digital signal processing circuit 14 and the CD-ROM decoder 15 are controlled by the microcomputer 17 not to operate, and the buffer RAM 16 operates in a different way as in the playback operation.

A counter 18 is connected to the binarizing circuit 13, and reads in the EFM signal supplied from the binarizing circuit 13. The counter 18 counts counter clocks of a higher frequency than the EFM signal in each H or L period of the EFM signal, and writes the count values sequentially into the buffer RAM 16. For a CLV operation of constant linear velocity at single speed, the 1T of the EFM signal is about 230 ns, and accordingly, the counter 18 counts counter clocks having one period of, e.g., 2 ns, that is, 500 MHz in frequency. In this case, when the H or L period of the EFM signal is “3T” (about 690 ns), the ideal count is 345; when the H or L period of the EFM signal is “4T”, the ideal count is 460; . . . ; and when the H or L period of the EFM signal is “11T”, the ideal count is 1265.

After performing the above series of processes on a given area of data recorded on the optical disk 11, the microcomputer 17 evaluates jitter by analyzing the count values stored in the buffer RAM 16.

In conventional optical disk apparatuses having the jitter evaluation function like the CD recording/playback apparatus 100, the counter 18 needs to use counter clocks of a higher frequency than the other circuits in order to improve accuracy (resolution) in measuring the H/L periods of the EFM signal. However, since the counter clocks of higher frequency are used, the power consumption of the counter 18 itself and the entire optical disk apparatus inevitably increases.

Furthermore, for sequential circuits using flip-flop circuits such as the counter 18, according to a prescribed design standard, the operable frequency is restricted suppressing the increase of their circuit scale. Hence, with the above conventional mechanism, there is a limit to the increase in the frequency of the counter clocks and thus the improvement of accuracy in measuring the H/L periods of the EFM signal due to the restriction on the circuit scale.

### SUMMARY OF THE INVENTION

According to one aspect of the present invention to solve the above and other problems, there is provided an optical disk apparatus which evaluates an optical disk based on a reproduced signal from the optical disk, comprising a delay circuit that has a plurality of first delay elements connected in series which have a binarized signal of the reproduced signal supplied to one end of the series and delay the binarized signal in a sequence to the other end, a data hold circuit that holds level data of the binarized signal obtained from at least one of the plurality of first delay elements of the delay circuit, and a processor that determines whether the binarized signal is at one level or at the other level based on the level data.

According to the present invention, there are provided an optical disk apparatus and a method of evaluating an optical disk which are suitable for improving jitter evaluation accuracy.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a diagram illustrating the configuration of an optical disk apparatus according to a first implementation of the present invention;

FIG. 2 is a diagram illustrating the detailed configuration of part of the optical disk apparatus according to the first implementation of the present invention;

FIG. 3 is a diagram showing an example of level data held together in a data hold circuit according to the first implementation of the present invention;

FIG. 4 is a diagram explaining the operation of the optical disk apparatus according to the first implementation of the present invention;

FIG. 5 is a diagram illustrating the detailed configuration of part of an optical disk apparatus according to a second implementation of the present invention;

FIG. 6 is a diagram illustrating the entire configuration of an optical disk apparatus according to a third implementation of the present invention;

FIG. 7 is a diagram explaining a write strategy according to the third implementation of the present invention;

FIG. 8 is a diagram explaining a Gray Zone according to a fourth implementation of the present invention;

FIG. 9 is a diagram illustrating the detailed configuration of part of an optical disk apparatus according to the fourth implementation of the present invention;

FIG. 10 is a diagram explaining the operation of the optical disk apparatus according to the fourth implementation of the present invention; and

FIG. 11 is a diagram illustrating the entire configuration of a conventional optical disk apparatus.

### DETAILED DESCRIPTION OF THE INVENTION

At least the following matters will be made clear by the explanation in the present specification and the description of the accompanying drawings.

<First Implementation>

==Configuration of Optical Disk Apparatus==

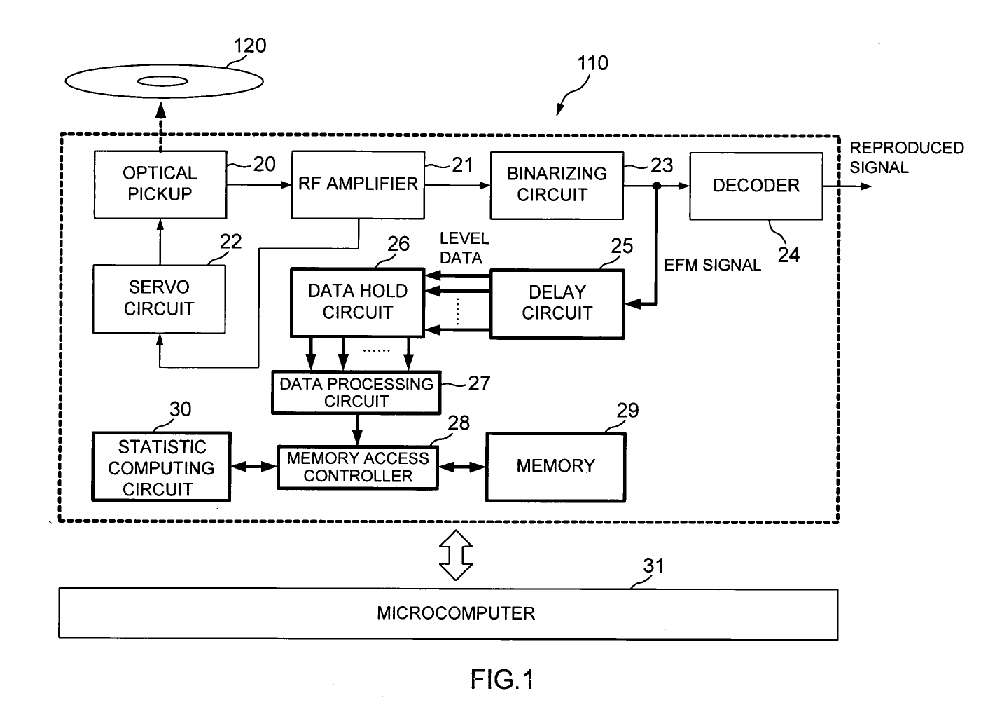

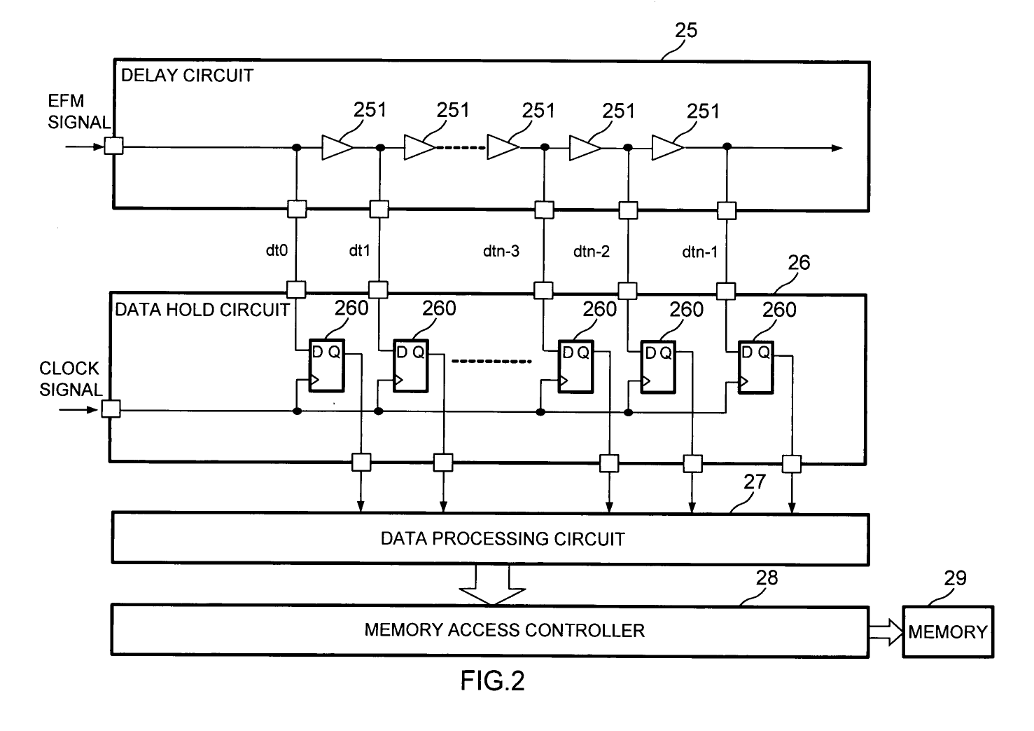

The configuration of an optical disk apparatus 110 according to an implementation of the present invention will be described based on FIG. 1 with reference to FIG. 2. Herein, the optical disk apparatus 110 is an apparatus that plays back information with irradiating laser light onto an optical disk 120 such as a CD/DVD medium. Needless to say, the apparatus 110 may be an apparatus that can also record on optical disks.

Moreover, the optical disk apparatus 110 has the function of quantitatively evaluating to what degree the playback signal obtained from the optical disk 120 deviates in timing, which is called jitter. By evaluating the jitter, the recording and playback qualities of the optical disk 120 are evaluated. Note that as described in detail later, the jitter is quantitatively evaluated based on results of measuring the H/L periods of the EFM signal.

An optical pickup 20 irradiates laser light onto the optical disk 120 and plays back information recorded on the optical disk 120. The optical pickup 20 receives reflected light of the laser light irradiating the optical disk 120 and picks up the high/low in intensity of the reflected light to output in the form of a change in voltage value.

An RF amplifier 21 amplifies the signal from the optical disk 120 picked up by the optical pickup 20 to a level that the process at the later stage can handle, and produces an RF signal (reproduced signal). Also, the RF amplifier 21 has an AGC (Automatic Gain Control) function of automatically controlling its own gain and a function of producing various servo control signals such as a tracking error signal and a focus error signal.

A servo circuit 12 controls various servo mechanisms provided in the optical pickup 20 according to the servo control signals produced by the RF amplifier 21. By this means, tracking servo, focus servo, and the like of the optical pickup 20 is performed so that the pickup 20 can read out in the correct order, data corresponding to pits and lands recorded on the optical disk 120.

A binarizing circuit 23 is a circuit that has the RF signal from the RF amplifier 21 inputted thereto and that binarizes the RF signal, and is constituted by, for example, a comparator that compares the level of the RF signal and a predetermined slice level. The binarized RF signal is supplied to a decoder 24 when in a normal mode, and to a delay circuit 25 when in an optical disk evaluation mode. The binarized RF signal is an EFM (8 to 14 modulation) signal for CD media, and an EFM-Plus (8 to 16 modulation) signal for DVD media. In the later description, the optical disk 120 is a CD medium and the binarized RF signal is the EFM signal.

The decoder 24 performs EFM-demodulation on the EFM signal supplied from the binarizing circuit 23, and performs error correction of a CIRC scheme on the EFM-demodulated signal. This decoded signal is output to the outside via an A/D converter (not shown).

The delay circuit 25 is configured to have a plurality of first delay elements 251 connected in series as shown in FIG. 2. The EFM signal is supplied to the input side of the delay circuit 25 and delayed sequentially across to the output side. The delay amount dt of the first delay element 251 is set equal to “the reference period 1T of the EFM signal divided by the number S of stages of the first delay elements 251”.

For example, when the number S of stages of the first delay elements 251 forming the delay circuit 25 is 16, the delay amount dt of one first delay element 251 is set equal to T/16. In this case, with the EFM signal being supplied to the input side of the delay circuit 25, each first delay element 251 delays the EFM signal by T/16 in sequence. And after the EFM signal is transmitted across the delay circuit 25, which takes the reference period 1T of the EFM signal, the H/L level data of the EFM signal delayed by T/16 in sequence from the input side to the output side are buffered in the first delay elements 251.

A data hold circuit 26 is for holding level data of the EFM signal obtained from ones of the first delay elements 251 of the delay circuit 25 together as shown in FIG. 2. The data hold circuit 26 comprises a plurality of flip-flop circuits 260 the number of which corresponds to the number of level data to be held together. The plurality of flip-flop circuits 260 have respective level data of the EFM signal obtained from the delay circuit 25 inputted thereto and hold them together on the basis of a common clock signal.

Note that the data hold circuit 26, as shown in FIG. 2, may hold together the level data from all the first delay elements 251 of the delay circuit 25, or the level data from ones apart by a predetermined number of ones from each other (e.g., the even or odd numbered) of the first delay elements 251.

A data processing circuit 27 converts a plurality of the level data held in the data hold circuit 26 to a data format that a microcomputer 31 can easily analyze. The microcomputer 31 may perform the processing of the data processing circuit 27, but it is better to provide the data processing circuit 27 in order to reduce the workload of the microcomputer 31.

The processing of the data processing circuit 27 is, for example, as follows. It is unknown the level data group corresponding to which 1T period of the EFM signal the plurality of level data held in the data hold circuit 26 belong to. Accordingly, the data processing circuit 27 analyzes the level data group corresponding to the period of 3T or longer from the data hold circuit 26 and identifies a polarity inversion timing (or transition) from H to L or from L to H in the level data group. Based on the identified polarity inversion timing, the H/L period data and the H/L polarity data, indicating which polarity the H/L period has, of the EFM signal are produced.

A memory access controller 28 controls access (write/read) to a memory 29. For example, the memory access controller 28 controls the writing of data produced by the data processing circuit 27 into a given memory area of the memory 29. The memory 29 is a storage device accessible to the microcomputer 31 such as a DRAM or an SDRAM.

A statistic computing circuit 30 reads out measured data of the EFM signal stored in the memory 29 via the memory access controller 28, performs various statistic computation on the data, and writes the results into a given memory area of the memory 29. The statistic computing circuit 30 computes, for example, the occurrence frequency of each H/L period (3T to 11T) in the EFM signal.

The microcomputer 31 controls the entire optical disk apparatus 110. In particular, the microcomputer 31 determines the length of the H/L period of the EFM signal from the plurality of level data held together in the data hold circuit 26. The microcomputer 31 makes into a histogram the occurrence frequencies of the respective H/L periods (3T to 11T) in the EFM signal stored in the memory 29 and evaluates jitter quantitatively. Note that the jitter evaluation is not limited to a histogram, but may be performed by computing another statistic value such as the average or the variance.

==Example of Operation of Optical Disk Apparatus==

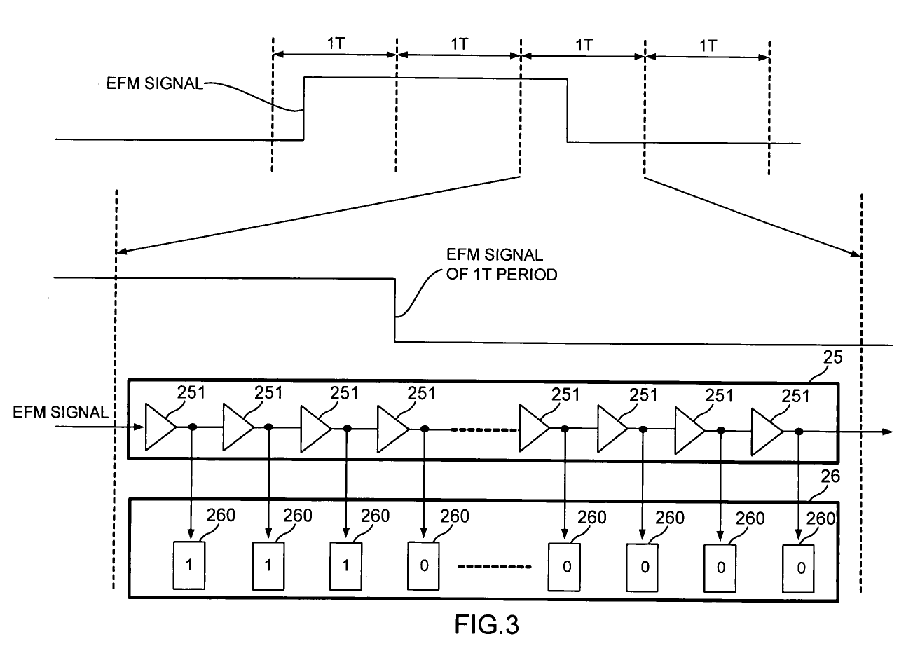

The implementation where the data hold circuit 26 holds together a plurality of level data from the delay circuit 25 will be described with reference to FIG. 3.

When the time period after the start of the transmission of the EFM signal through the delay circuit 25 reaches the reference period 1T of the EFM signal, the H/L level data of the EFM signal delayed in sequence in the order of from the input side to the output side are buffered in the first delay elements 251 forming the delay circuit 25. Accordingly, each time the reference period 1T of the EFM signal elapses, the data hold circuit 26 latches and holds together a plurality of the level data from the delay circuit 25 corresponding to the reference period 1T of the EFM signal.

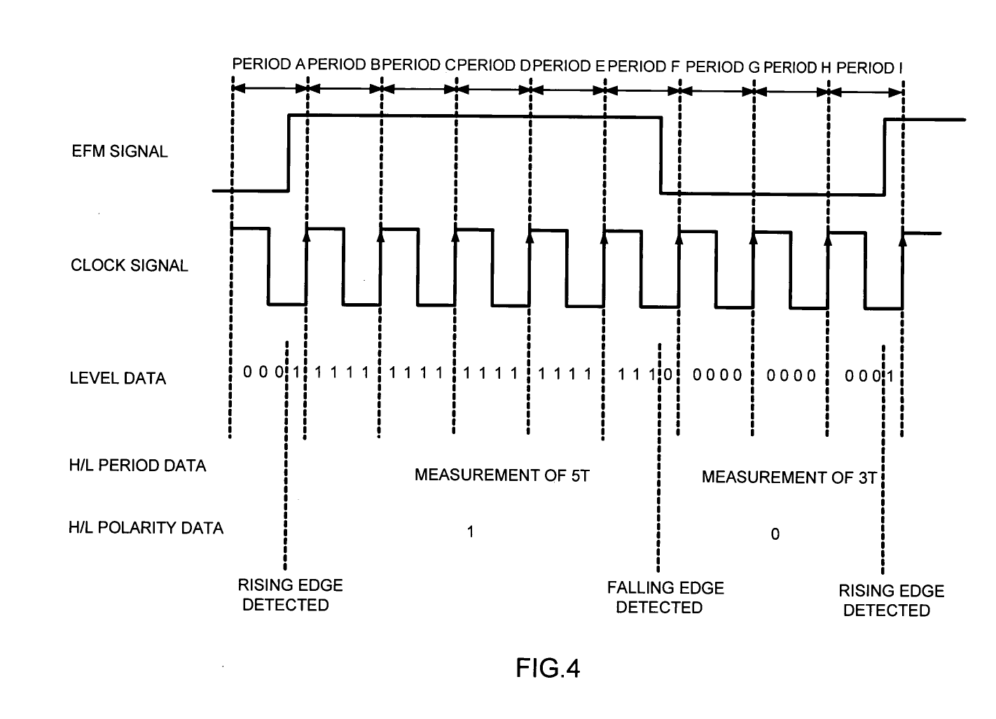

The implementation where the plurality of level data held together in the data hold circuit 26 are used for jitter evaluation will be described with reference to FIG. 4. This Figure shows the case where the number S of stages of the first delay elements 251 forming the delay circuit 25 is four, and where the data hold circuit 26 has four flip-flop circuits 260 that are supplied respectively with the delayed signals from the four first delay elements 251.

In the example of the Figure, the 5T H-level period of the EFM signal can be seen in the level data group held together in the data hold circuit 26 over a total period of 6T of periods A to F.

The data processing circuit 27 analyzes the level data group held together in the data hold circuit 26 from period A to period F. As a result, a L to H polarity inversion timing of the EFM signal is identified from level data of “0001” corresponding to period A; level data from period B to period E are consecutively at “1”; and a H to L polarity inversion timing of the EFM signal is identified from level data of “1110” corresponding to period F.

Thus, the data processing circuit 27 generates H/L period data indicating the measured length of the 5T H-level period of the EFM signal on the basis of the polarity inversion timings identified in periods A and F, and H/L polarity data indicating that the data in the H/L period is H. Then, these measured data are written into a given memory area of the memory 29 via the memory access controller 28.

In the example of the Figure, the 3T L-level period of the EFM signal can be seen in the level data group held together in the data hold circuit over a total period of 4T of periods F to I. The processing of the data processing circuit 27 for this case is the same as for the 5T H-level period of the EFM signal, and hence a description thereof is omitted.

==Example of Effects==

In the above implementation, the plurality of level data held together in the data hold circuit 26, that are data obtained together from the delay circuit 25, are sampled data in the time period corresponding to the delay amount of the delay circuit 25 (e.g., the reference period 1T of the EFM signal). In order to determine the length of the H/L period of the EFM signal for the evaluation of the optical disk, the microcomputer 31 can refer to the sampled data in the time period corresponding to the delay amount of the delay circuit 25 at one time.

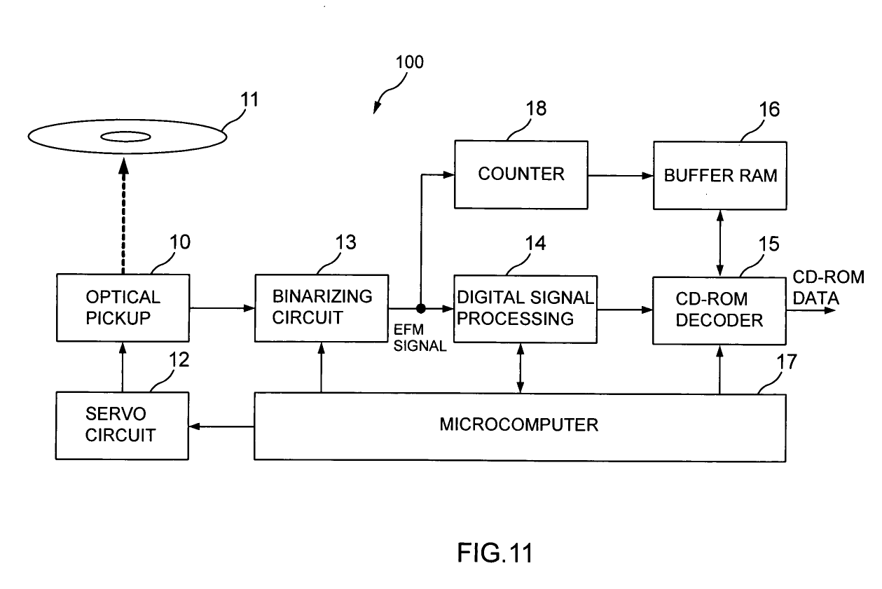

That is, according to the above implementation, each H/L period of the EFM signal need not be measured in sequence with counter clocks like in the conventional scheme using the counter 18 as shown in FIG. 11. Therefore, when improving accuracy (resolution) in measuring each H/L period of the EFM signal, various restrictions associated with raising the frequency of counter clocks and the like for the conventional scheme are not valid for the implementation.

Furthermore, in the above implementation, the plurality of flip-flop circuits 260 of the data hold circuit 26 hold together the plurality of level data obtained from the delay circuit 25 on the basis of the common clock signal. That is, in the above implementation, sequential measurement with counter clocks is not performed like in the conventional scheme.

Hence, to achieve measurement accuracy of the same order as with the conventional scheme, the common clock signal used for the plurality of flip-flop circuits 260 can be of a lower frequency than counter clocks of the conventional scheme. For example, let f1 be the frequency of counter clocks of the conventional scheme and n be the number of obtained level data, i.e., the number of flip-flop circuits 260. Then, in order for the implementation to achieve measurement accuracy of the same order as with the conventional scheme, the common clock signal used for the plurality of flip-flop circuits 260 is of a frequency of f1/n.

Moreover, in the above implementation, the data hold circuit 26 holding together the respective level data obtained from the first delay elements 251 of the delay circuit 25 maximizes accuracy in measuring the H/L periods of the EFM signal.

Yet further, in the above implementation, the data hold circuit 26 holding together the level data obtained from ones, apart by a predetermined number of ones from each other, of the first delay elements 251 of the delay circuit 25 reduces the number of flip-flop circuits 260 and thus circuit scale.

<Second Implementation>

==Delay Adjustment by PLL Circuit==

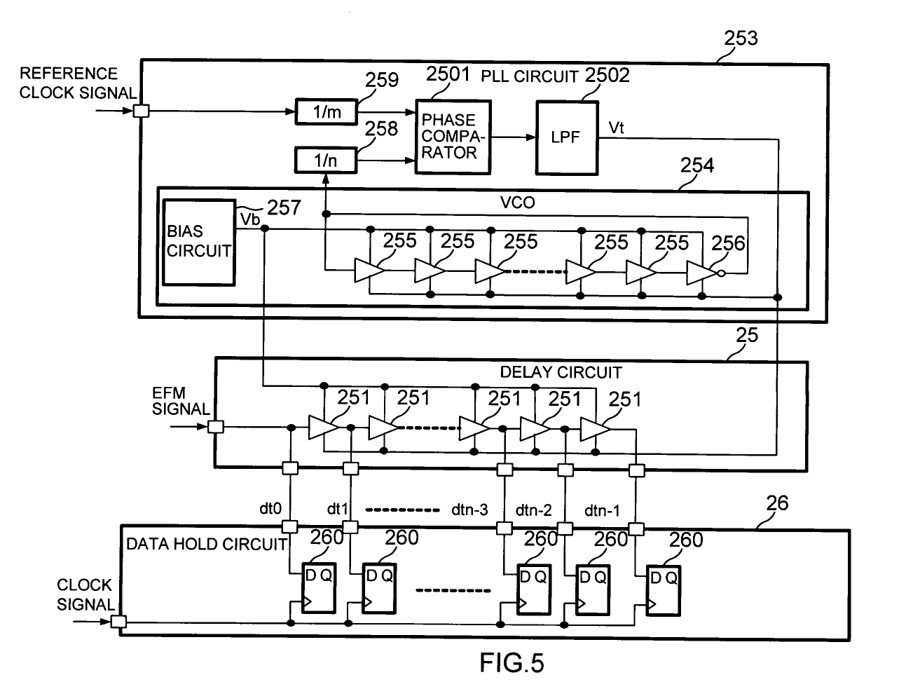

In the above implementation, the first delay elements 251 forming the delay circuit 25 vary in delay amount due to temperature variation, production variation, or the like. Accordingly, in order to accurately set the delay amount of the delay circuit 25, a PLL circuit 253 as shown in FIG. 5 is provided for controlling the delay amount of the delay circuit 25.

First, the configuration of the delay circuit 25 provided with the PLL circuit 253 of FIG. 5 will be described.

The PLL circuit 253 comprises a VCO 254, a first divider 258, a second divider 259, a phase comparator 2501, and a LPF 2502.

The VCO 254 has a plurality of second delay elements 255 connected like a ring. The plurality of second delay elements 255 are connected in series, and the output of the second delay element 255 of the last stage is fed back to the input of the second delay element 255 of the first stage via an inverter 256.

A bias voltage Vb generated by a bias circuit 257 is supplied to one power supply terminal of each second delay element 255, and a control voltage Vt is supplied from the LPF 2502 to the other power supply terminal of each second delay element 255. In the VCO 254, the delay amount of each second delay element 255 is controlled via the control voltage Vt.

The first divider 258 divides the frequency of the output signal of the VCO 254 to 1/n thereof. The second divider 259 divides the frequency of a reference clock signal supplied from outside the PLL circuit 253 to 1/m thereof.

The phase comparator 2501 performs a phase comparison between the divided signal of the first divider 258 and the divided signal of the second divider 259. Incidentally, where the first divider 258 and the second divider 259 are not provided, the phase comparator 2501 performs a phase comparison between the output signal of the VCO 254 and the reference clock signal.

The LPF 2502 generates the control voltage Vt corresponding to the output signal of the phase comparator 2501. A control signal generated by the phase comparator 2501 is output to the LPF 2502 via a charge pump circuit.

In the delay circuit 25, the EFM signal is delayed sequentially by first delay elements 251 connected in series as described previously. The bias voltage Vb from the bias circuit 257 is supplied to one power supply terminal of each first delay element 251, and the control voltage Vt is supplied from the LPF 2502 to the other power supply terminal of each first delay element 251.

Next, the operation of the delay circuit 25 provided with the PLL circuit 253 will be described.

First, the PLL circuit 253 controls the control voltage Vt so as to eliminate the phase difference at the phase comparator 2501, and thus gets in lock. Here, let f1 be the frequency of the output signal of the VCO 254 and f0 be the frequency of the reference clock signal, then an equation 1 “f1/n=f0/m” holds true.

Meanwhile, in the VCO 254, the delay amount dt of each second delay element 255 is set by the control voltage Vt from the LPF 2502; the signal inputted to the second delay element 255 of the first stage is delayed by each second delay element 255 in sequence; and the output of the second delay element 255 of the last stage is inverted and fed back to the second delay element 255 of the first stage. Thus, an equation 2 “half a period T/2 of VCO 254 output=delay amount dt×number S of stages of second delay elements 255” holds true.

Obtained from the above equations 1 and 2 is an equation 3: dt=(m/n)×(½S·f0). That is, when the number S of stages of second delay elements 255 and the divisors m and n are decided, the delay amount dt of the second delay element 255 is a constant value depending on only the frequency f0 of the reference clock signal.

Furthermore, the first delay elements 251 forming the delay circuit 25 are the same in structure as the second delay elements 255 of the VCO 254, and have the bias voltage Vb and the control voltage Vt supplied like the second delay elements 255. Hence, the delay amount of the first delay element 251 of the delay circuit 25 is the same as the delay amount dt of the second delay element 255 of the VCO 254, and is a constant value depending on the frequency f0 of the reference clock signal when the PLL circuit 253 is in lock.

As above, by providing the delay circuit 25 with the PLL circuit 253, variation in delay amounts of the first delay elements 251 due to various factors such as temperature variation, production variation, and the like is suppressed thereby stabilizing the delay amounts. Also, as a result, it becomes possible to measure the H/L periods of the EFM signal stably.

<Third Implementation>

==Sharing with Write Strategy Circuit==

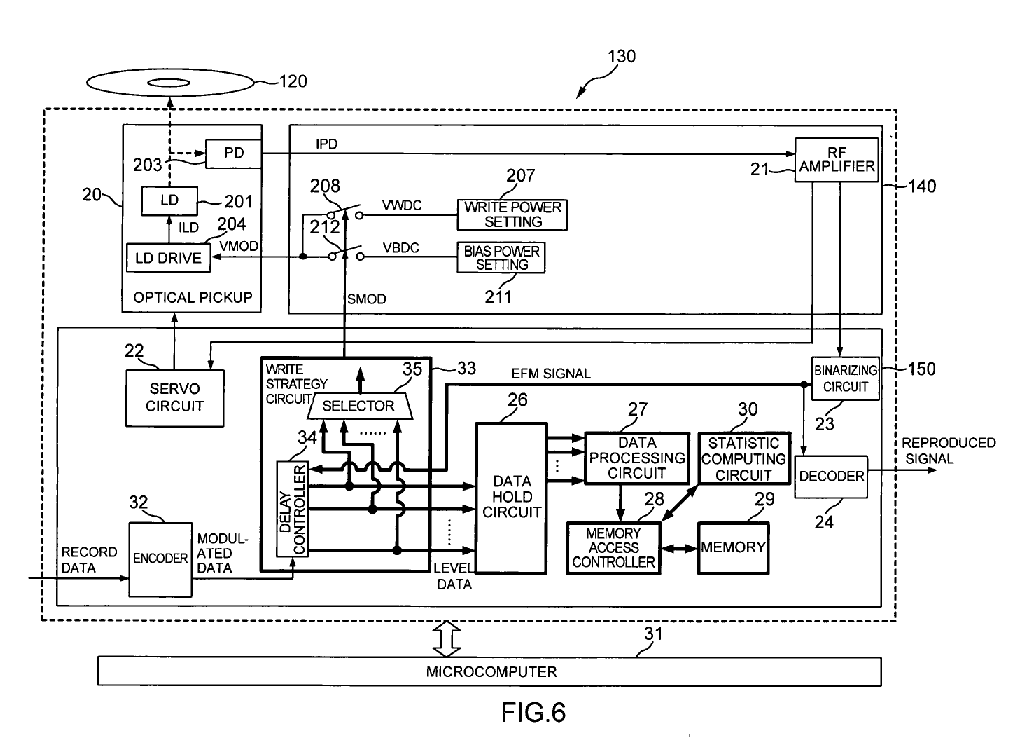

FIG. 6 is a diagram showing the configuration of an optical disk apparatus 130 according to another implementation of the present invention. The same reference numerals indicate the same or like parts as in the optical disk apparatus 110 of FIG. 1, and a description thereof is omitted.

The optical disk apparatus 130 comprises an optical pickup 20, an analog signal processing circuit 140, a digital signal processing circuit 150, and a microcomputer 31, and is an apparatus that records and plays back information with irradiating laser light onto the optical disk 120.

The optical pickup 20 comprises an LD 201, a PD 203, an LD drive circuit 204, and others such as an objective lens and various servo mechanisms.

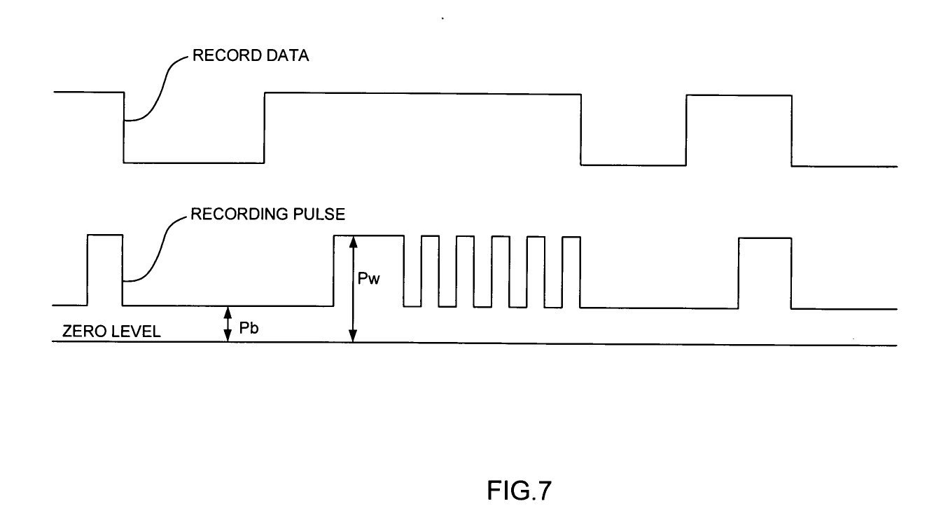

The LD 201 is a light emitting element that emits laser light for record/playback to the optical disk 120 according to a drive current ILD supplied from the LD drive circuit 204. For the optical disk 120 being a write-once optical disk, the method of driving the LD 201 (a write strategy) uses a pattern of a multi-pulse modulation scheme as shown in FIG. 7. A recording pulse consists of a top pulse and multiple pulses so as to create one record mark with controlling heat distribution through the record mark. Note that this recording pulse has two power levels, write power Pw and bias power Pb.

The PD 203 is a light receiving element that receives part of reflected light from the optical disk 120 and produces a photocurrent IPD proportional to the intensity of the received light. The photocurrent IPD is converted into a voltage and supplied to an RF amplifier 21. As a result, the RF amplifier 21 produces an RF signal and various servo control signals.

The LD drive circuit 204 generates the drive current ILD for driving the LD 201 according to a modulated signal Vmod generated by switching the ON/OFF of switches 208, 212.

The analog signal processing circuit 140 is for processing analog signals for driving an optical disk, and has, e.g., the RF amplifier 21 which produces the RF signal and various servo control signals.

A write power setting section 207 generates a write power signal VWDC, which is supplied to the LD drive circuit 204 if the switch 208 is ON.

A bias power setting section 211 generates a bias power signal VBDC, which is supplied to the LD drive circuit 204 if the switch 212 is ON.

Thus, the LD drive circuit 204 drives the LD 201 according to the modulated signal Vmod that is a combined signal of the write power signal VWDC generated by the write power setting section 207 and the bias power signal VBDC generated by the bias power setting section 211. As a result, as shown in FIG. 7, the LD 201 outputs recording pulses having write power Pw and bias power Pb.

The digital signal processing circuit 150 is for performing digital signal processes for controlling an optical disk such as a digital servo process and an encode/decode process. That is, the digital signal processing circuit 150 includes the parts in the dashed frame in FIG. 1 except the optical pickup 20 and the RF amplifier 21. Also, the optical disk apparatus 130 further comprises an encoder 32 and a write strategy circuit 33 for recording on optical disks.

The encoder 32 performs prescribed modulation according to the standard of the optical disk 120 on data (such as image, voice, or video data) to be recorded thereon, supplied from an external apparatus (a personal computer or the like).

The write strategy circuit 33 generates a modulated switch signal Smod based on modulated data obtained by the encoder 32 performing prescribed modulation on the record data, and outputs the modulated switch signal Smod to the switches 208, 212. Thus, by switching the ON/OFF of switches 208, 212 according to the modulated switch signal Smod, the modulated signal Vmod to be supplied to the LD drive circuit 204, i.e., recording pulses for recording on the optical disk 120, is generated.

Furthermore, it has been proposed to provide the write strategy circuit 33 with a delay controller 34 and a selector 35 for sending the recording pulses generated by the write strategy circuit 33 to the laser mechanism not directly but with delays, as a measure against variation in the recording state depending on the type of optical disk 120 and rotation speed. See, e.g., FIG. 2 of Japanese Patent Application Laid-Open Publication No. H11-273252.

The delay controller 34 has a circuit that consists of a plurality of stages of delay elements connected in series, and a PLL circuit for controlling the delay amounts of the delay elements like the delay circuit 25 of FIG. 5. The delay controller 34 delays a signal for generating the recording pulses such as the EFM signal generated by the encoder 32 sequentially by the delay elements connected in series whose delay amounts are set by the PLL circuit.

The selector 35 selects one of the delay elements connected in series of the delay controller 34 and outputs as a delayed signal. Based on this delayed signal, the modulated switch signal Smod and thus recording pulses, suitable for various recording states, are generated.

Hence, in the optical disk apparatus 130, the delay controller 34 of the write strategy circuit 33, which has the same configuration as the delay circuit 25 combined with the PLL circuit 253 of FIG. 5 is shared as the delay circuit 25. That is, the EFM signal produced by the binarizing circuit 23 is supplied to the input of the delay elements connected in series of the delay controller 34 and delayed sequentially, and the data hold circuit 26 holds together a plurality of level data of the EFM signal obtained from all or some of the delay elements connected in series of the delay controller 34. Hence, the optical disk apparatus 130 does not need to have another instance of the delay circuit 25 combined with the PLL circuit 253 of FIG. 5. Therefore, the circuit scale and power consumption of the digital signal processing circuit 150 can be reduced.

<Fourth Implementation>

==Gray Zone==

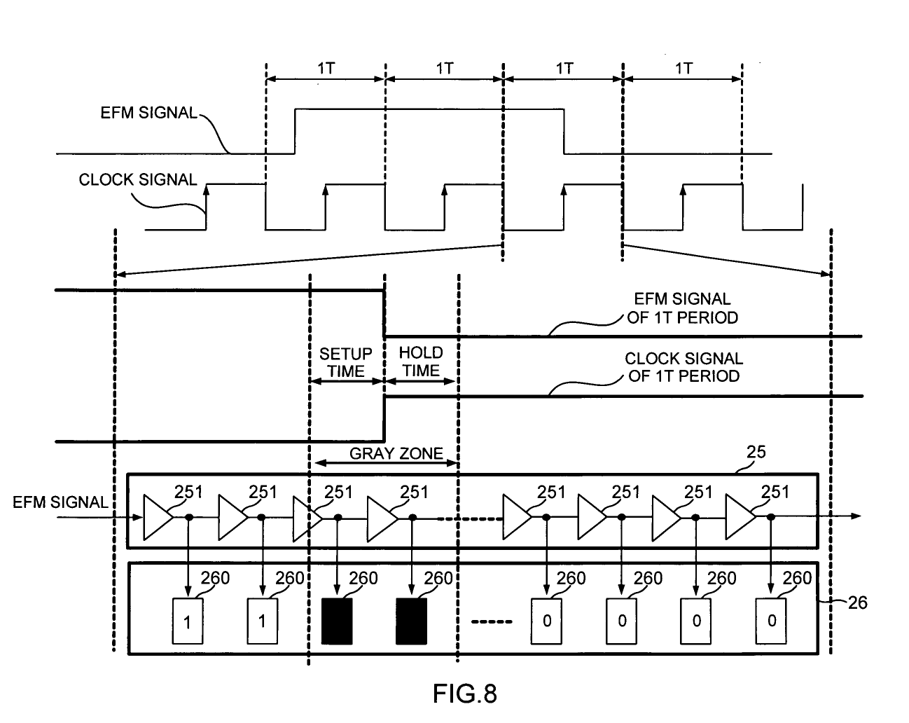

In the above implementation, for the flip-flop circuits 260 of the data hold circuit 26, since the input data (level data) and the clock signal are asynchronous, cases can occur where the time difference between a polarity inversion timing when the EFM signal changes from H to L or from L to H and an edge timing when the clock signal changes from H to L or from L to H is extremely small. FIG. 8 shows how the delay circuit 25 and the data hold circuit 26 operates in these cases.

As shown in FIG. 8, at the flip-flop circuit 260 whose input level change occurs near an edge timing of the clock signal, the event that it is indefinite which level is read in, H or L, may occur because of setup time and hold time. Hereinafter, the time period including setup time and hold time relative to edge timings of the clock signal supplied to the flip-flop circuits 260 is called a “Gray Zone”.

==Measure Against Gray Zone==

As a measure against the Gray Zone, for each of the plurality of level data held together in the data hold circuit 26, a correlation coefficient with two level data before and after it is calculated, and based on the correlation coefficient, the polarity inversion timing of the EFM signal level is determined.

The data processing circuit 27 calculates the correlation coefficients and based on the correlation coefficients, determines the polarity inversion timing of the EFM signal level. Thus, the microcomputer 31 can determine the lengths of the H/L periods of the EFM signal based on the determined polarity inversion timings of the EFM signal without considering Gray Zones. Therefore, jitter evaluation accuracy is further improved.

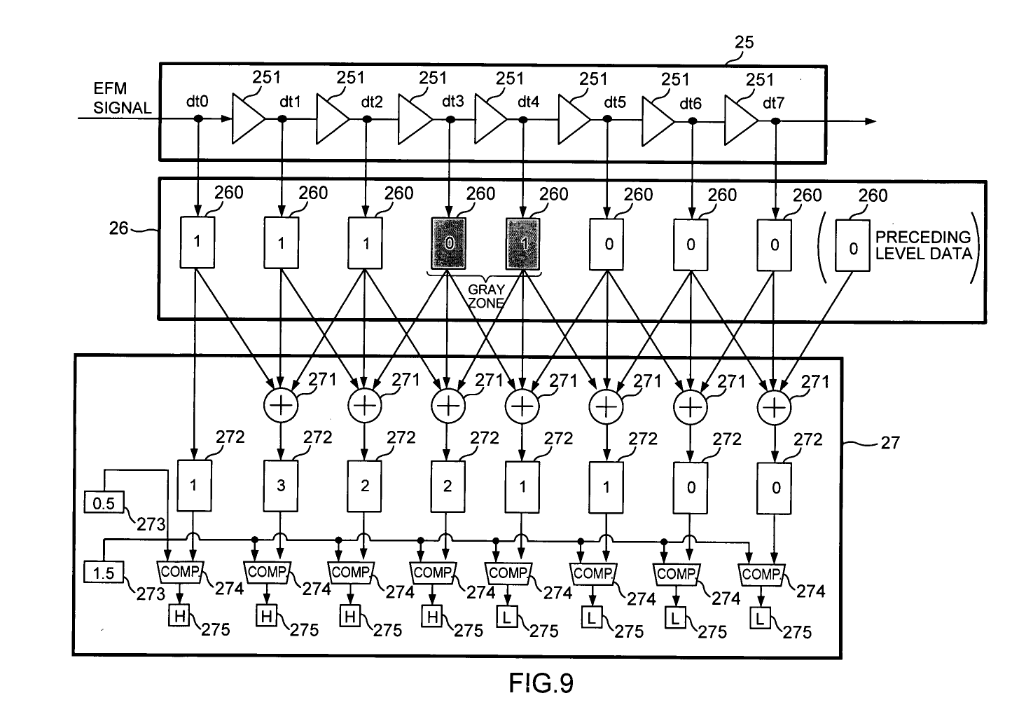

FIG. 9 is a diagram illustrating an example of the mechanism as a measure against the Gray Zone, provided in the data processing circuit 27.

The data processing circuit 27 comprises adders 271, addition result storing registers 272, a threshold value storing register 273, comparators 274, and comparison result storing registers 275.

The adder 271 is provided corresponding to each flip-flop circuit 260 of the data hold circuit 26, and adds corresponding level data and two level data before and after it out of the level data group held in the flip-flop circuits 260 of the data hold circuit 26, the three level data being consecutive in sequence. The addition result is stored in the addition result storing register 272.

The adder 271, associated with the flip-flop circuit 260 holding level data from the output end of the delay circuit 25, uses as level data before the corresponding level data in time, level data at the input of the delay circuit 25 in the preceding cycle of reference period 1T of the EFM signal, which is then held by the data hold circuit 26.

The comparators 274 compare the addition results stored in the addition result storing registers 272 and a predetermined threshold value stored in the threshold value storing register 273. The comparison results are stored in the comparison result storing registers 275.

Next, the way to determine a polarity inversion timing of the EFM signal by the data processing circuit 27 will be described.

As shown in FIG. 9, suppose that two flip-flop circuits 260 hold the level data associated with the Gray Zone. The two level data associated with the Gray Zone are indefinite in terms of taking on 1 or 0. Furthermore, as to the flip-flop circuits 260 holding level data before the level data of the two flip-flop circuits 260 in time and the flip-flop circuits 260 holding level data after in time, their data levels are inverted from each other.

There is a H to L polarity inversion timing in the plurality of level data held in the data hold circuit 26. Here, three level data consecutive in time-series not including the two level data associated with the Gray Zone are (1, 1, 1) or (0, 0, 0), and the correlation coefficient is calculated to be 3 or 0.

Meanwhile, three level data consecutive in time-series including both the two level data associated with the Gray Zone are (1, 0, 1) or (0, 1, 0), and the correlation coefficient is calculated to be 2 or 1.

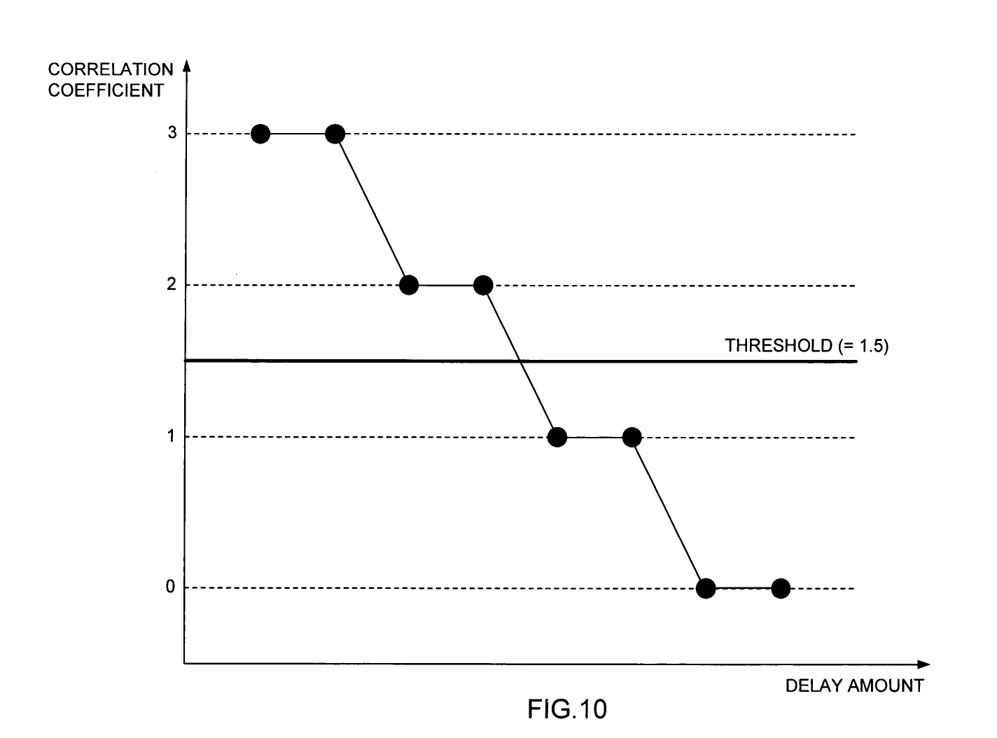

As such, the correlation coefficients associated with the two level data associated with the Gray Zone change from 2 to 1 in time-series inevitably. Accordingly, as shown in FIG. 10, the data processing circuit 27 compares the correlation coefficient (3, 2, 1, or 0), i.e., the sum of three level data consecutive in time-series with a threshold value of 1.5 to determine such a change in the correlation coefficients associated with the two level data associated with the Gray Zone. As a result, the data processing circuit 27 can reliably determine the polarity inversion timing of the EFM signal without considering the Gray Zone.

Note that the data processing circuit 27 may store beforehand tabular information containing three level data consecutive in time-series in association with their correlation coefficients. That is, the data processing circuit 27 obtains three level data consecutive in time-series held in the data hold circuit 26, and their corresponding correlation coefficients from the tabular information stored beforehand. Thus, the polarity inversion timings of the EFM signal can be determined reliably.

Although the implementations of the present invention have been described, the above implementations are provided to facilitate the understanding of the present invention and not intended to limit the present invention. It should be understood that various changes and alterations can be made therein without departing from spirit and scope of the invention and that the present invention includes its equivalents.

What is claimed is:

1. An optical disk apparatus which evaluates an optical disk based on a reproduced signal from the optical disk, comprising:
a delay circuit that has a plurality of first delay elements connected in series which have a binarized signal of the reproduced signal supplied to one end of the series and delay the binarized signal in a sequence to the other end;
a data hold circuit that holds level data of the binarized signal obtained from at least one of the plurality of first delay elements of the delay circuit; and
a processor that determines whether the binarized signal is at one level or at the other level based on the level data.

2. The optical disk apparatus according to claim 1, further comprising:
a PLL circuit that produces a control voltage based on a reference clock signal and its output signal and produces the output signal that oscillates according to the control voltage,
wherein the delay circuit controls delay amounts of the first delay elements according to the control voltage.

3. The optical disk apparatus according to claim 1, wherein the data hold circuit has a corresponding number of flip flop circuits to the number of the level data, and
wherein a plurality of the flip flop circuits have a plurality of the level data of the binarized signal obtained from the delay circuit respectively inputted thereto and hold them.

4. The optical disk apparatus according to claim 3, wherein the data hold circuit holds together the respective level data obtained from the first delay elements of the delay circuit.

5. The optical disk apparatus according to claim 3, wherein the data hold circuit holds together the level data obtained from ones, apart by a predetermined number of ones from each other, of the first delay elements of the delay circuit.

6. The optical disk apparatus according to claim 1, further comprising:
a write strategy circuit that generates recording pulses for recording on the optical disk from modulated data obtained by performing prescribed modulation on record data for the optical disk, and is provided with a delay controller for controlling a delay amount of a signal for generating the recording pulses,
wherein the delay controller provided in the write strategy circuit is shared as the delay circuit.

7. The optical disk apparatus according to claim 2, further comprising:
a write strategy circuit that generates recording pulses for recording on the optical disk from modulated data obtained by performing prescribed modulation on record data for the optical disk, and is provided with a delay controller for controlling a delay amount of a signal for generating the recording pulses,
wherein the delay controller provided in the write strategy circuit is shared as the delay circuit.

8. The optical disk apparatus according to claim 3, further comprising:
a data processing circuit that determines polarity of each of the plurality of level data held together in the data hold circuit on the basis of a correlation coefficient of each of the level data held with the level data positioned in series,
wherein the processor determines whether the binarized signal is at one level or at the other level on the basis of the polarity determined by the data processing circuit.

9. The optical disk apparatus according to claim 8, wherein for each of the plurality of level data held together in the data hold circuit, the correlation coefficient is a sum of the level data and two level data before and after it, and the data processing circuit determines the polarity on the basis of the result of comparing the sum with a predetermined threshold value.

10. A method of evaluating an optical disk based on a reproduced signal from the optical disk, comprising the steps of:
supplying a binarized signal of the reproduced signal to one end of a plurality of first delay elements connected in series to have the binarized signal delayed in a sequence to the other end;
holding level data of the binarized signal obtained from at least one of the plurality of first delay elements of the delay circuit; and
determining whether the binarized signal is at one level or at the other level based on the level data.
